(19) United States
(12) Patent Application Publication
(10) Pub. No.: US 2009/0016631 A1
(43) Pub. Date: Jan. 15, 2009

(54) Video Coding Rate Control

(75) Inventors: Tomoyuki Naito, Ibaraki (JP); Akira Osamoto, Ibaraki (JP); Akihiro Yonemoto, Tokyo (JP)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/169,877

(22) Filed: Jul. 9, 2008

Related U.S. Application Data
(60) Provisional application No. 60/948,843, filed on Jul. 10, 2007.

(51) Int. Cl. H04N 7/26

(52) U.S. Cl. 382/251; 375/240.03

(57) ABSTRACT

The video encoding rate control with the quantization parameter modulated by macroblock activity with macroblock activity measured using 16×16 intra-prediction mode SAD evaluations.

### CROSS-REFERENCE TO RELATED APPLICATIONS

This application claims priority from provisional patent application No. 60/948,843, filed Jul. 10, 2007. The following co-assigned copending patent applications disclose related subject matter: application Ser. No. 11/694,399, filed Mar. 30, 2007. All of which are incorporated herein by reference.

### BACKGROUND

The present invention relates to digital video signal processing, and more particularly to devices and methods for video coding.

There are multiple applications for digital video communication and storage, and multiple international standards for video coding have been and are continuing to be developed. Low bit rate communications, such as, video telephony and conferencing, led to the H.261 standard with bit rates as multiples of 64 kbps, and the MPEG-1 standard provides picture quality comparable to that of VHS videotape. Subsequently, H.263, MPEG-2, and MPEG-4 standards have been promulgated.

H.264/AVC is a recent video coding standard that makes use of several advanced video coding tools to provide better compression performance than existing video coding standards. At the core of all of these standards is the hybrid video coding technique of block motion compensation (prediction with motion vector) plus transform coding of prediction error. Block motion compensation is used to remove temporal redundancy between successive pictures (frames or fields) by prediction from prior pictures, whereas transform coding is used to remove spatial redundancy within each block of both temporal and spatial prediction errors. FIGS. 2a-2c illustrate H.264/AVC functions which include a deblocking filter within the motion compensation loop to limit artifacts created at block edges.

Traditional block motion compensation schemes basically assume that between successive pictures an object in a scene undergoes a displacement in the x- and y-directions and these displacements define the components of a motion vector. Thus an object in one picture can be predicted from the object in a prior picture by using the object's motion vector. Block motion compensation simply partitions a picture into blocks and treats each block as an object and then finds its motion vector which locates the most-similar block in a prior picture (motion estimation). This simple assumption works out in a satisfactory fashion in most cases in practice, and thus block motion compensation has become the most widely used technique for temporal redundancy removal in video coding standards. Further, periodically pictures coded without motion compensation are inserted into the picture sequence to avoid error propagation; blocks encoded without motion compensation are called intra-coded, and blocks encoded with motion compensation are called inter-coded.

Block motion compensation methods typically decompose a picture into macroblocks where each macroblock contains four 8×8 luminance (Y) blocks plus two 8×8 chrominance (Cb and Cr or U and V) blocks, although other block sizes, such as 4×4, are also used in H.264/AVC. The residual (prediction error) block can then be encoded (i.e., block transformation, transform coefficient quantization, entropy encoding). The transform of a block converts the pixel values of a block from the spatial domain into a frequency domain for quantization; this takes advantage of decorrelation and energy compaction of transforms such as the two-dimensional discrete cosine transform (DCT) or an integer transform approximating a DCT. For example, in MPEG and H.263, 8×8 blocks of DCT-coefficients are quantized, scanned into a one-dimensional sequence, and coded by using variable length coding (VLC). H.264/AVC uses an integer approximation to a 4×4 DCT for each of sixteen 4×4 Y blocks and eight 4×4 chrominance blocks per macroblock. Thus an inter-coded block is encoded as motion vector(s) plus quantized transformed residual block.

Similarly, intra-coded pictures may still have spatial prediction for blocks by extrapolation from already encoded portions of the picture; this implies during decoding these portions will be available for the reconstruction. Typically, pictures are encoded in raster scan order of blocks, so pixels of blocks above and to the left of a current block can be used for prediction. H.264/AVC has multiple options for intra-prediction: the size of the block being predicted and the direction of extrapolation from the block bounding pixel values to generate the prediction pixel values. Again, transformation of the prediction errors for a block can remove spatial correlations and enhance coding efficiency. FIGS. 2a-2b illustrate encoder functions for H.264/AVC.\

The rate-control in FIGS. 2b and 2d is responsible for generating the quantization step (QP) by adapting to a target transmission bit-rate and the output buffer-fullness. Indeed, video streams are generally provided with a designated bit-rate for the compressed bit-stream. The bit-rate varies depending on the desired image quality, the capacity of storage/communication channel, etc. In order to generate compressed video streams of the specified bit-rate, a rate controller is implemented in practical video encoding systems. In the recent video coding standards, the bit-rate can be controlled through the quantization step size, which is used to quantize sample coefficients so that it may determine how much of spatial detail is retained. When the quantization step size is very small, the bit-rate is high and almost all of the picture detail is saved. As the quantization step size is increased, the bit-rate decreases at the cost of some loss of quality. The goal of the rate control is to achieve the target bit-rate by adjusting the quantization step size while minimizing the total loss of quality. A rate control algorithm may greatly affect the overall image quality even at a given bit-rate.

MPEG-2 Test Model 5 (TM5) rate control has achieved widespread familiarity as a constant bit rate (CBR), one-pass rate control algorithm. The one-pass rate control algorithms are suitable for real time encoding systems because the encoding process is performed only once for each picture. However, the quantization step size shall be determined prior to the encoding process. TM5 rate control algorithm determines the quantization step size in three steps: (1) bit allocation, (2) rate control, and (3) adaptive quantization. In essence, step 1 assigns a budget of bits to the current picture based on the statistics obtained from previously encoded pictures. Then, to achieve the assigned budget, step 2 adjusts the quantization step size during the encoding process using a feedback loop. While the steps 1 and 2 are included to achieve higher compression efficiency, step 3 is included to improve subjective image quality by allocating relatively more bits to areas with small spatial activity. Indeed, the human eye is more sensitive to noise in areas with roughly constant luminance than in areas with rapid variation of luminance.

However, the known methods of spatial activity measurement in rate control are computationally burdensome for mobile devices with limited processor power and limited battery life, such as camera cellphones.

### SUMMARY OF THE INVENTION

The present invention provides video encoding rate control with macroblock activity estimated by intra-coding evaluations.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a flowchart.

FIGS. 2a-2f show video coding functions.

FIGS. 3a-3b illustrate a processor and network communication.

FIGS. 4-5 show parameter relations.

### DESCRIPTION OF THE PREFERRED EMBODIMENTS

### 1. Overview

Preferred embodiment video encoding methods provide rate control with a measure of macroblock activity derived from macroblock intra-prediction mode computations. For H.264/AVC, a macroblock has multiple intra-prediction mode possibilities, and an encoder typically selects the mode with the smallest cost in terms of distortion plus an offset to account for number of bits. The preferred embodiment methods re-use this cost computation in the macroblock activity measurement for rate control.

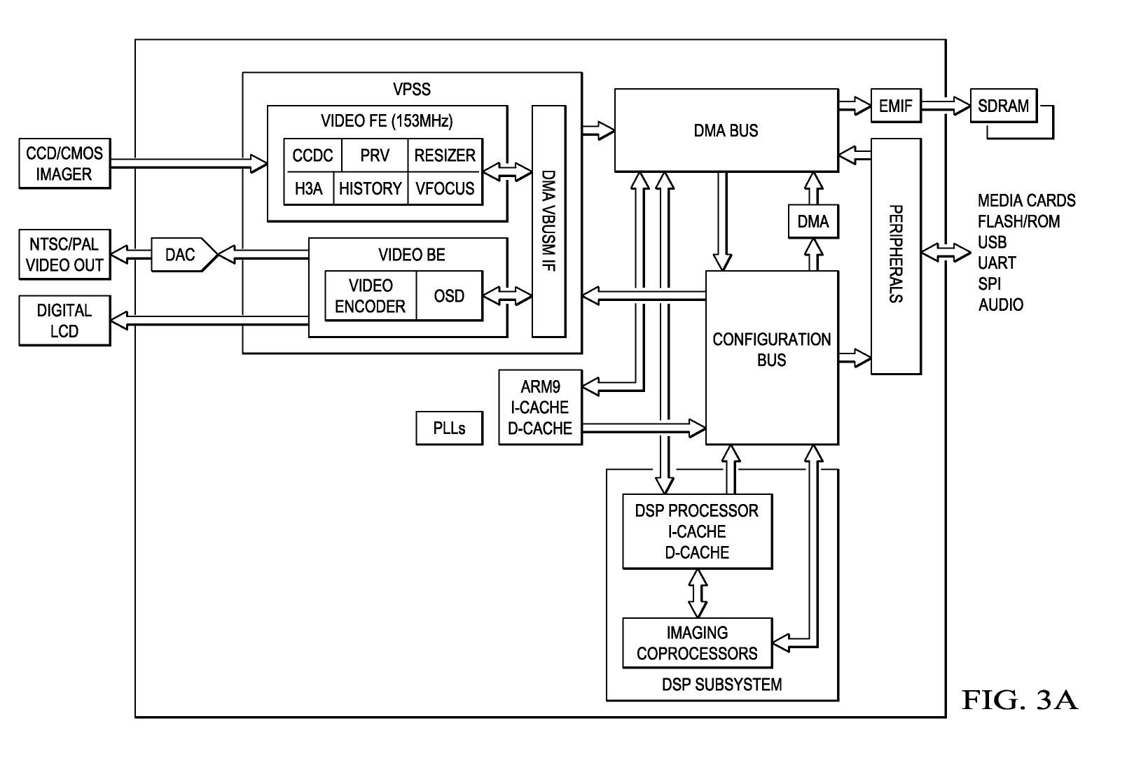

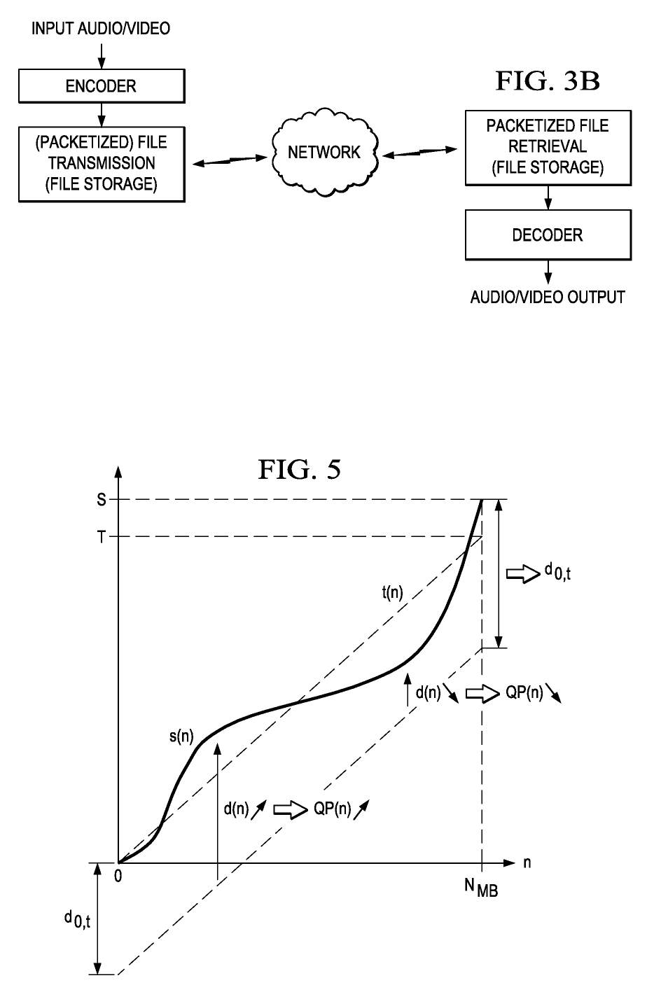

Preferred embodiment systems (e.g., camera cellphones, PDAs, digital cameras, notebook computers, etc.) perform preferred embodiment methods with any of several types of hardware, such as digital signal processors (DSPs), general purpose programmable processors, application specific circuits, or systems on a chip (SoC) such as multicore processor arrays or combinations such as a DSP and a RISC processor together with various specialized programmable accelerators (e.g., FIG. 3a). A stored program in an onboard or external (flash EEP) ROM or FRAM could implement the signal processing methods. Analog-to-digital and digital-to-analog converters can provide coupling to the analog world; modulators and demodulators (plus antennas for air interfaces such as for video on cellphones) can provide coupling for transmission waveforms; and packetizers can provide formats for transmission over networks such as the Internet as illustrated in FIG. 3b.

### 2. TM5 Rate Control

In order to explain preferred embodiment video encoding methods for H.264/AVC, first consider the TM5 rate control, in more detail. TM5 rate control was developed for MPEG-2 with 8×8 DCT transforms for both intra- and inter-coded macroblocks: TIM5 controls a quantizer scale with feedback for quantizing the 64 coefficients of inter-coded 8×8 residual (motion prediction error) blocks and the 63 AC coefficients of intra-coded 8×8 blocks. In particular, for the residual transform coefficients, first apply a relative weighting:

ac˜(i,j)=16*ac(i,j)//wN(i,j) i=0, 1, . . . , 7, j=0, 1, . . . , 7

where // denotes a round-off integer division and wN(i,j) is a fixed matrix with integer elements increasing from 16 to 33 as the spatial frequency increases. Then quantize by integer division with quantizer_scale:

QAC(i,j)=ac˜(i,j)/(2*quantizer_scale) i=0, 1, . . . , 7, j=0, 1, . . . , 7

where quantizer_scale is determined in a feedback process having three steps: (1) bit allocation, (2) rate control, and (3) adaptive quantization.

TM5 analogously quantizes intra-coded 8×8 blocks of transform coefficients (except for the DC coefficient) with a division including weighting matrix elements wI(i,j) and a final division by 2*quantizer_scale.

TM5 determines quantizer_scale using feedback as follows.

Step 1: Bit Allocation

This step assigns a budget of bits to each group of pictures (GOP), and then to individual pictures within the GOP hierarchically. A GOP contains an initial I-picture and includes all of the subsequent pictures in encoding order, although display order may differ. The bit allocation proceeds with a variable, R [bits], which denotes the number of remaining bits assigned to the GOP. The variable R is set to zero prior to the encoding process of a video sequence. Before encoding a GOP, the bit budget for the GOP is assigned (updated) as

R=R+bit_rateN_{GOP}/picture_rate

where N_{GOP} [pics] is the number of pictures in the GOP, bit_rate is the bit rate [bits/sec], and picture_rate is the picture_rate [pics/sec].

Then, before encoding a picture, R is allocated to the picture in proportion to both the current global complexity measure and the number of remaining pictures. Each picture type has a global complexity measure, and after encoding a picture, the corresponding picture global complexity measurement for that picture type (I, P, or B) is updated:

X_{I}=S_{I}Q_{Iave}

X_{P}=S_{P}Q_{Pave}

X_{B}=S_{B}Q_{Bave}

where S_{I}, S_{P}, or S_{B} was the number of bits generated by encoding the picture if the picture was an I-, P-, or B-picture, respectively, and Q_{Iave}, Q_{Pave}, or Q_{Bave} was the corresponding average of the quantization step size used during the encoding of the picture. The global complexity measures may be initialized as:

X_{I}=bit_rate*160/115

X_{P}=bit_rate*60/115

X_{B}=bit_rate*42/115

By computing the global complexity measure for previously encoded pictures, the TM5 rate control evaluates the bit-rate for the current picture before performing the actual encoding process.

The ideas underlying the global complexity measure are as follows. Initially, video sequences with various picture sizes (e.g., QCIF, CIF and SD) are encoded with an H.264/AVC encoder for illustrative purposes. In the H.264/AVC standard, the quantization step size (Q), which roughly corresponds to quantizer_scale of TM5, is exponentially related to the encoded quantization parameter (QP) as

Q=Q₀2^{QP/6}

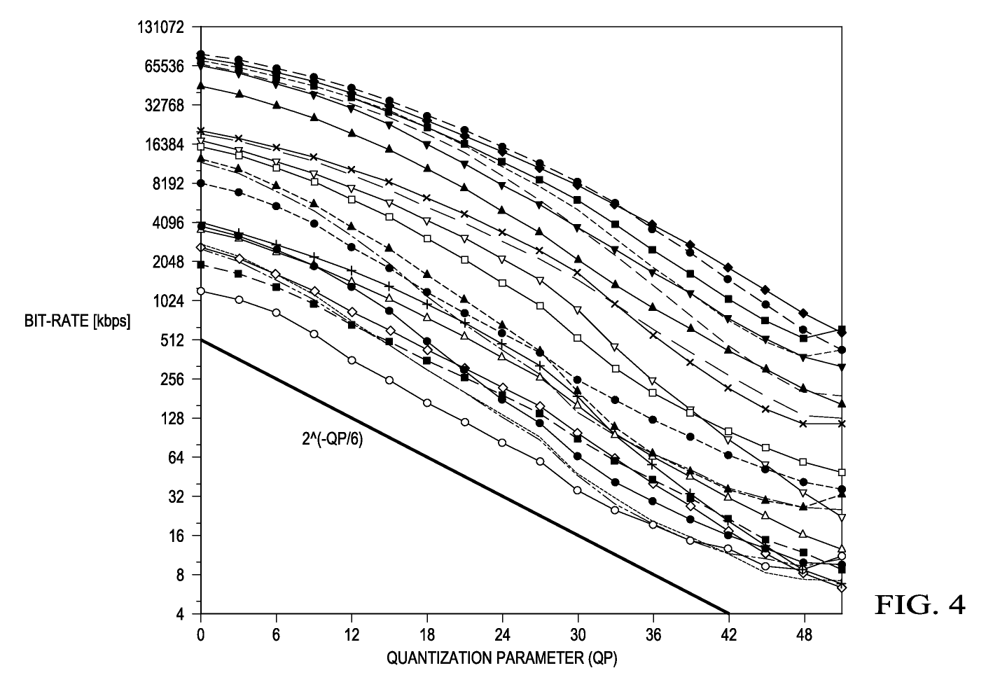

FIG. 4 shows the bit-rate when these video sequences are encoded with constant QPs. As can be seen from the figure, the bit-rate is roughly inversely proportional to the quantization step size, and thus the rationale for the foregoing global complexity definitions.

Note that the complexity of pictures differs from sequence to sequence and it further depends on picture type. A macroblock in an I-picture only has intra-prediction from within the picture; in a P-picture a macroblock may refer to past I-/P-pictures only; and in B-pictures a macroblock may refer to I-/P-pictures in both the past and future. Hence, the complexity of P-pictures tends to be smaller than that of I-pictures, and likewise, the complexity of B-pictures tends to be smaller than that of P-pictures. The picture complexity is therefore computed for each picture type separately, and the initialization reflects the differing picture type complexities.

Next, the target number of bits for encoding the current picture (in the group of pictures) is computed according to picture type using the corresponding current complexity measure:

T_{I}=max{bit_rate/(8*picture_rate),RX_{I}/(X_{I}+X_{P}N_{P}/K_{P}+X_{B}N_{B}/K_{B})}

T_{P}=max{bit_rate/(8*picture_rate),RX_{P}/(X_{P}N_{P}+K_{P}X_{B}N_{B}/K_{B})}

T_{B}=max{bit_rate/(8*picture_rate),RX_{B}/(X_{B}N_{B}+K_{B}X_{P}N_{P}/K_{P})}

where K_{P} and K_{B} are universal constants dependent upon the quantization matrices (for the MPEG-2 matrices wN(i,j) and wI(i,j), K_{P}=1.0 and K_{P}=1.4), N_{P} and N_{B} are the number of P-pictures and B-pictures, respectively, remaining in the group of pictures being encoded, and R is the remaining number of bits assigned to the group of pictures. R is updated after encoding a picture: the actual number of bits generated (one of S_{I}, S_{P}, or S_{B}) is subtracted from the number of remaining bits, R:

R=R−S_{I,P,B}

Before encoding the first picture (an I-picture) in a group of pictures, R is initialized as

R=R+N*bit_rate/picture_rate

where N is the number of pictures in the group of pictures. (Prior to initialization at the start of a video sequence, that is, prior to the first group of pictures, R=0.)

Step 2: Rate Control

According to the bit budget for the current picture, T_{I}, T_{P}, or T_{B}, the QP is determined using the corresponding virtual buffer fullness. Each picture type has a virtual buffer, and before encoding the n-th picture, the virtual buffer fullnesses, d_{I}(n), d_{P}(n), and d_{B}(n), are updated by:

Then, determine a reference quantization step size Q_{ref} for the encoding of the n-th macroblock by

d_{I}(n)=d_{I}(0)+B(n−1)−T_{I}*(n−1)/MB_{—}cnt

d_{P}(n)=d_{P}(0)+B(n−1)−T_{P}*(n−1)/MB_{—}cnt

d_{B}(n)=d_{B}(0)+B(n−1)−T_{B}*(n−1)/MB_{—}cnt

where d_{I}(0), d_{P}(0), and d_{B}(0), are the initial virtual buffer fullness for the I-, P-, and B-picture types, respectively, for the current picture, B(n−1) is the total number of bits generated by encoding all of the macroblocks in the current picture prior to the n-th macroblock, MB_cnt is the total number of macroblocks in the current picture, and thus T_{I,P,B}*(n−1)/MB_cnt is the fraction of the bit target for the current picture which should have been used prior to the n-th macroblock. (Note that the final fullness of each virtual buffer is used as the initial fullness of the corresponding virtual buffer in the subsequent picture; i.e., d_{I}(0) of the next picture equals d_{I}(MB_cnt) of the current picture.)

Then, determine a reference quantization step size Q_{ref} for the encoding of the n-th macroblock by

Q_{ref}(n)=d(n)/r

Where the subscript I, P, or B has been omitted and r is the reaction parameter that adjusts the feedback response for the current picture type. The reaction parameter r may be defined by

r=2*bit_rate/picture_rate

Thus this reaction parameter is 2 times the average number of bits per picture for the video sequence.

The feedback works as follows. When an excessive number of bits are used with respect to the corresponding fraction of the budget target T_{I,P,B}, the buffer fullness d_{I,P,B}(n) increases due to B(n−1) being larger than the corresponding fraction of the budget target. Then, the quantization step size Q_{I,P,B}(n) is set larger, and the bit usage will be pulled down. Meanwhile, when an excessive number of bits are saved, the buffer fullness d_{I,P,B}(n) decreases. Then, Q_{I,P,B}(n) is decreased and the bit usage will be pulled up. Thus, the bit usage is controlled so that the budget target T_{I,P,B} will be achieved; see FIG. 5.

The initial value for the virtual buffer fullnesses are:

d_{I}(0)=10*r/31

d_{P}(0)=K_{P}*d_{I}(0)

d_{B}(0)=K_{B}*d_{I}(0)

Step 3

The final quantization step size will be the reference quantization step size modulated according to a measure of macroblock activity; this will trade off lower quantization step size for smooth picture areas with higher quantization step size for textured picture areas. Thus compute a spatial activity measure for the current n-th macroblock from the four luminance frame-organized 8×8 blocks (labelled 1,2,3,4) plus the four luminance field-organized (vertically-interleaved)8×8 blocks (labelled 5,6,7,8) of the current macroblock by taking the minimal block variance:

act(n)=1+min{vblk₁,vblk₂, . . . , vblk₈}

where the m-th 8×8 block variance is:

vblkₘ=( 1/64)Σ_{1≦j≦64}(Pₘ(j)−P_meanₘ)² for m=1, 2, . . . , 8

with Pₘ(j) denoting the luminance value of the j-th pixel in the m-th 8×8 block and P_meanₘ the average luminance value in the block:

P_meanₘ=( 1/64)Σ_{1≦j≦64}Pₘ(j)

Normalize act(n) by

N_act(n)=(2*act(n)+avg_act)/(act(n)+2*avg_act)

where avg_act is the average value of act(..) in the last picture to be encoded prior to the current picture. Initialize for the first picture of the group of pictures by taking avg_act=400. Note that this normalized activity is in the range from 0.5 when act(n) is much smaller than avg_act to 2.0 when act(n) is much larger than avg_act.

Lastly, obtain the quantization factor quantizer_scale for the n-th macroblock by:

mquant(n)=Q_{ref}(n)*N_act(n)

and clip mquant(n) to the range [1 . . . 31] to get quantizer_scale.

### 3. Intra-Prediction Modes for H.264/AVC

H.264/AVC has intra-prediction modes with partitioning of the macroblock luminance into a single 16×16, four 8×8, or sixteen 4×4 block sizes and with eight directional extrapolations from left or upper bounding pixels. In particular, the modes are:

For a 16×16 partition
mode 0: vertical downward (sixteen columns)
mode 1: horizontal to the right (sixteen rows)
mode 2: dc (average of the 32 bounding pixel values)
mode 3: plane (half diagonal down-left plus half diagonal up-right)

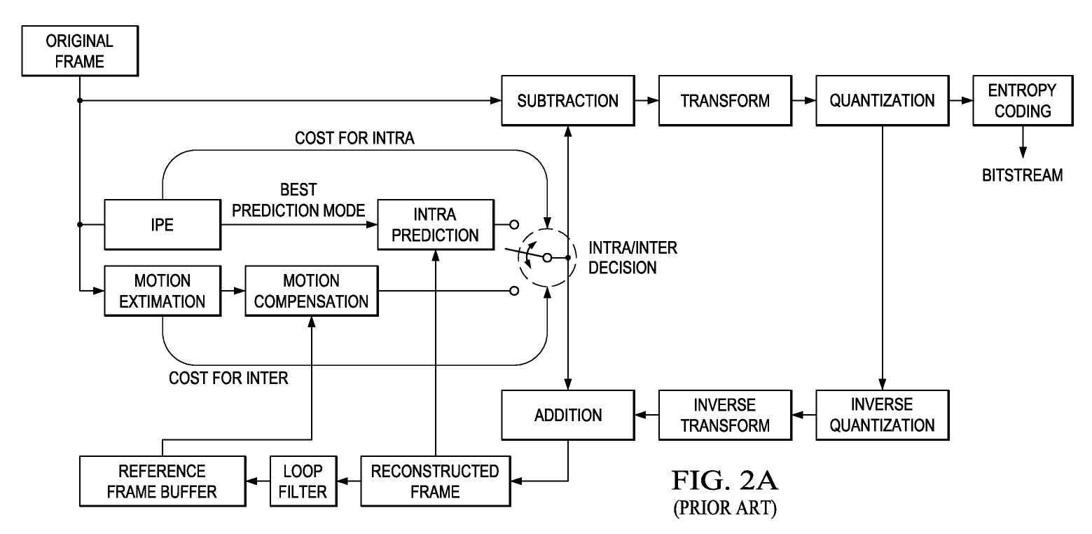

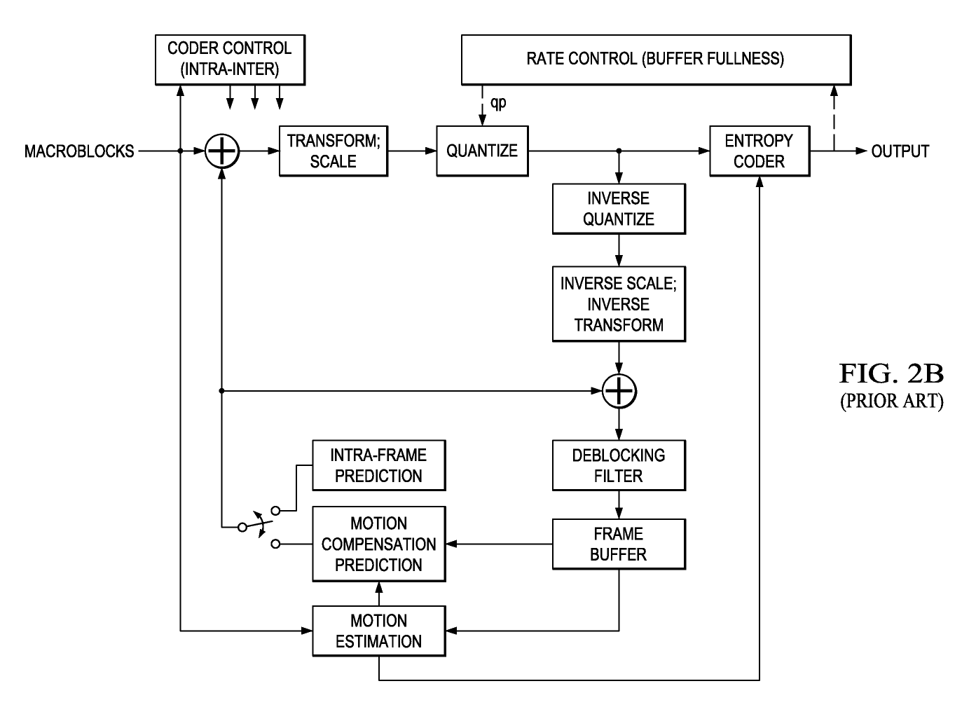

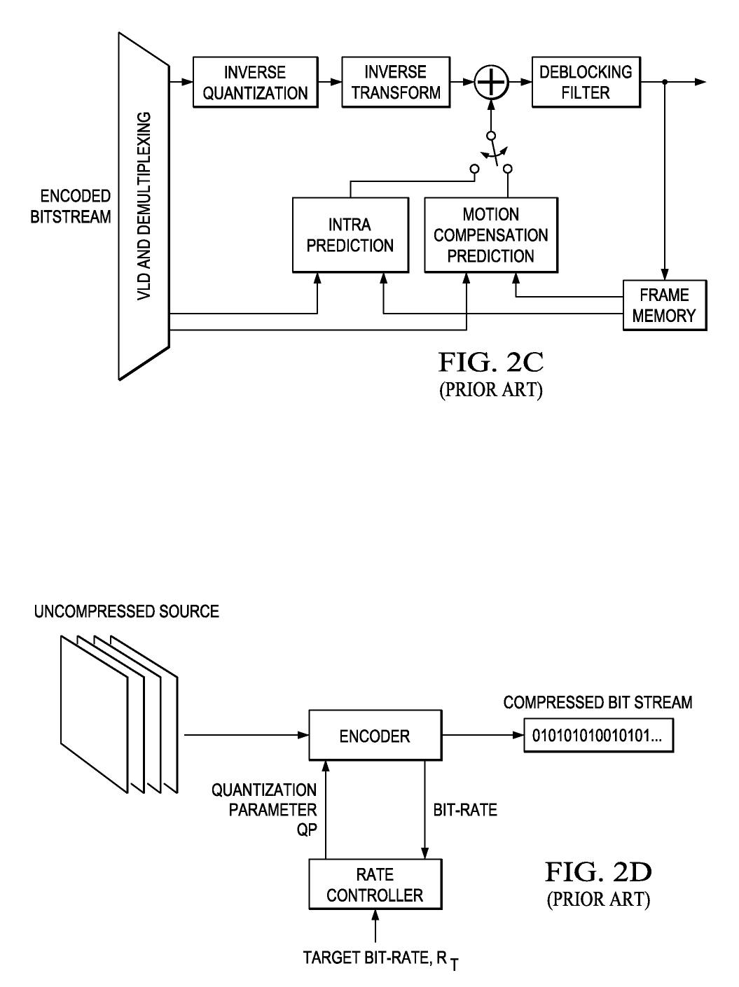

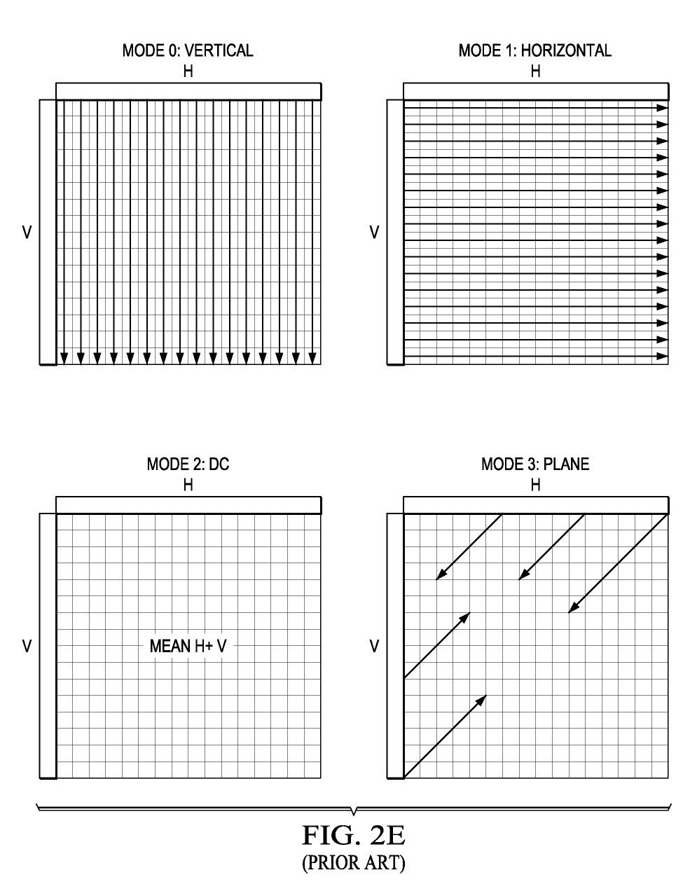

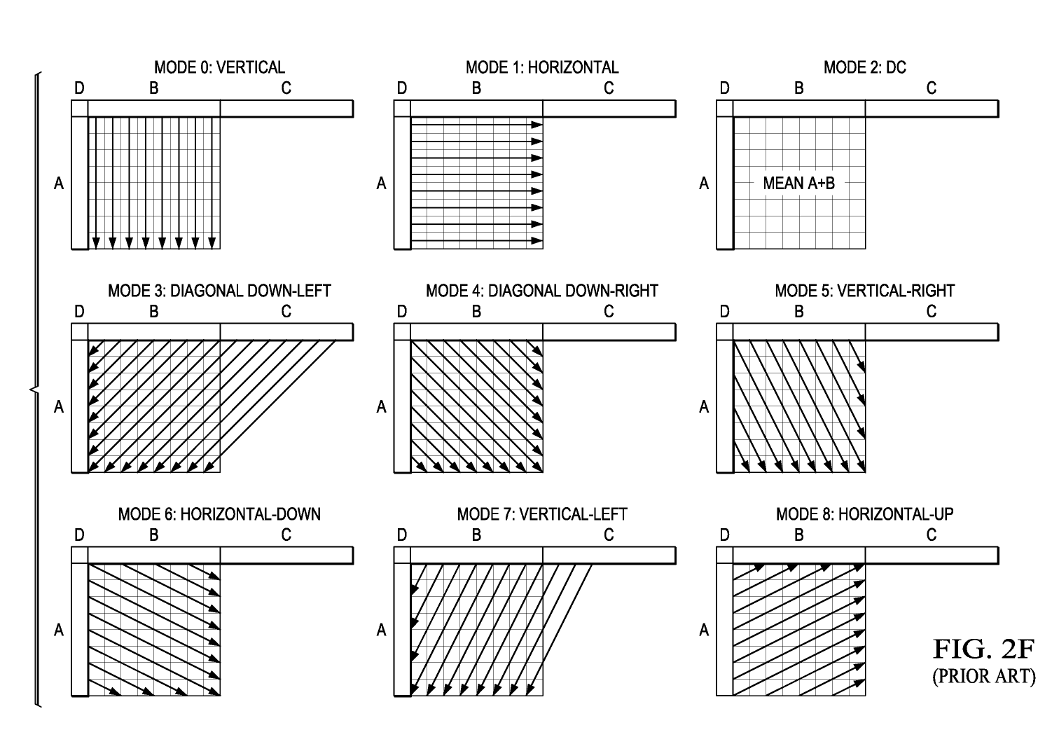

For a partition into 8×8 or 4×4
mode 0: vertical downward (eight or four columns)
mode 1: horizontal to the right (eight or four rows)
mode 2: dc (average of the 16 or 8 bounding pixel values)
mode 3: diagonal down-left
mode 4: diagonal down-right
mode 5: vertical right
mode 6: horizontal down
mode 7: vertical-left
mode 8: horizontal up
   The partitioning into small blocks is suitable for areas with much visual detail; whereas, the 16×16 block works well for smooth visual areas. FIGS. 2e-2f illustrate these modes for 16×16 and 8×8, respectively

For the current macroblock to be encoded in a picture, an encoder evaluates the possible partitions and intra-modes to find the “best” intra-mode which is then used for intra-coding and/or to decide between intra- and inter-coding (see FIGS. 2a-2b). The comparisons to find the “best” mode typically compute a cost for each mode; the cost C(m,p) may be computed as:

C(m,p)=D(m,p)+O(m,p)

where p denotes the partition (e.g., 16×16, 8×8, 4×4) and m the mode; D(m,p) is the distortion; and O(m,p) is the offset. D(m,p) may be measured as the sum over the pixels of absolute differences of a pixel value and its predicted value for partition p with mode m (i.e., the SAD for the prediction). O(m,p) is to estimate the bit overhead needed for encoding in the prediction mode (i.e., the cost can trade off between distortion and bit rate) and may be constant or include a variable according to the prediction modes of the upper and left macroblocks.

### 4. Rate Control

Preferred embodiment encoding methods for H.264/AVC include rate control methods like TM5 but which avoid computing the eight 8×8 block variances as part of the macroblock activity evaluation. Instead, preferred embodiment methods use the computation of D(m,p) of the intra-prediction mode evaluations and take:

act(..)=minₘ{D(m,16×16)}/4

=min_{16×16mode}{SAD_{16×16mode}}/4

FIG. 2e illustrates the four 16×16 intra-prediction modes which compute 16×16 SADs, and the minimum SAD corresponds to the minimal cost C(m,16×16) because the offset O(m,16×16) is the same for the four 16×16 modes. That is, the preferred embodiment H.264/AVC encoding methods use a TM5 rate control with the block variances,

minₘ( 1/64)Σ_{1≦j≦64}(Pₘ(j)−P_meanₘ)²,

approximated by the minimum 16×16 SAD already-computed as part of the intra-prediction mode evaluations,

min_{16×16mode}(¼)Σ_{1≦j≦256}|P(j)−P_pred_{16×16}mode(j)|,

where P(j) is the luminance value and P_Pred_{16×16}mode(j) the predicted luminance value for the j-th pixel of the macroblock.

Then with mquant(n) computed as in TM5 (but using the 16×16 SAD approximation for the block variances in the macroblock activity), take the H.264/AVC quantization parameter QP(n) for the n-th macroblock to be:

QP(n)=round{6 log₂ [mquant(n)]}+4

This provides the rate control for the H.264/AVC encoding.

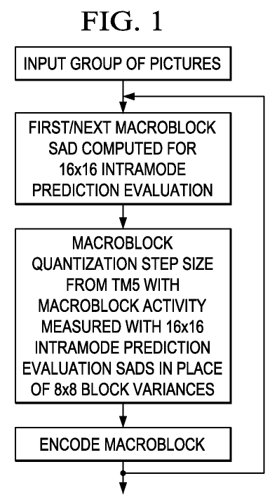

FIG. 1 is a flowchart for a preferred embodiment encoding method which includes the steps of:

(a) for a first macroblock, evaluating intra-coding prediction modes, said evaluating including computing a sum of absolute differences for at least one 16×16 prediction mode;

(b) for said first macroblock, providing a quantization step size by:
(1) computing a bit count for remaining uncoded pictures of a group of pictures including a current remaining picture which contain said first macroblock;
(2) using said bit count, computing a target number of bits for said current picture;
(3) using said target number of bits together with a second bit count of bits used to encode macroblocks in said current picture and encoded prior to said first macroblock, computing a virtual buffer fullness;
(4) using said virtual buffer fullness, computing a reference quantization step size;
(5) modulating said reference quantization step size by using macroblock activity for said first macroblock together with an average of macroblock activity for macroblocks of a prior picture of said group of picture where said prior picture has been encoded, wherein said macroblock activity for said first macroblock is determined by said sum of absolute differences for at least one 16×16 prediction mode;

(c) quantizing said first macroblock using said modulated reference quantization step size;

(d) repeating steps (a)-(c) with said first macroblock replaced by other macroblocks of said current picture; and

(e) repeating steps (a)-(d) with said current picture replaced by other pictures of said group of pictures.

### 5. Modifications

The preferred embodiment rate control methods may be modified in various ways while retaining one or more of the features of using intra-mode prediction evaluation SADs as measures of macroblock activity for quantization. For example, the various initial variable values and parameter values could be varied; pictures could be either frames or fields; and so forth.

While the foregoing is directed to embodiments of the present invention, other and further embodiments of the invention may be devised without departing from the basic scope thereof, and the scope thereof is determined by the claims that follow.

What is claimed is:

1. A method of encoding, comprising the steps of:
(a) for a first macroblock, evaluating intra-coding prediction modes, said evaluating including computing a sum of absolute differences for at least one 16×16 prediction mode;
(b) for said first macroblock, providing a quantization step size by:
(1) computing a bit count for remaining uncoded pictures of a group of pictures including a current remaining picture which contain said first macroblock;
(2) using said bit count, computing a target number of bits for said current picture;
(3) using said target number of bits together with a second bit count of bits used to encode macroblocks in said current picture and encoded prior to said first macroblock, computing a virtual buffer fullness;
(4) using said virtual buffer fullness, computing a reference quantization step size;
(5) modulating said reference quantization step size by using macroblock activity for said first macroblock together with an average of macroblock activity for macroblocks of a prior picture of said group of picture where said prior picture has been encoded, wherein said macroblock activity for said first macroblock is determined by said sum of absolute differences for at least one 16×16 prediction mode; and
(c) quantizing said first macroblock using said modulated reference quantization step size.

2. The method of claim 1 further comprising repeating steps (a)-(c) with said first macroblock replaced by other macroblocks of said current picture.

3. The method of claim 1 further comprising repeating steps (a)-(d) with said current picture replaced by other pictures of said group of pictures.
